(19) United States
(12) Patent Application Publication
(10) Pub. No.: US 2026/0266116 A1
(43) Pub. Date: Sep. 10, 2026

(54) PIVOTING OF A MOVABLE DOOR LEAF OF A VEHICLE DOOR

(71) Applicant: AUDI AG, Ingolstadt (DE)

(72) Inventor: Markus PETER, Reichertshofen (DE)

(73) Assignee: AUDI AG, Ingolstadt (DE)

(21) Appl. No.: 19/439,883

(22) Filed: Jan. 5, 2026

(30) Foreign Application Priority Data
Mar. 10, 2025 (DE) 102025108836.5

(51) Int. Cl. E05F 15/40; E05F 15/611

(52) U.S. Cl. CPC E05F 15/40; E05F 15/611; E05Y 2900/531

(57) ABSTRACT

A movable door leaf of a vehicle door. An electric drive device is activated to influence the pivoting of the door leaf, at least partially, between an open position and a closed position, depending on an actuating force exerted on the door leaf. When the drive device is activated, an obstacle detection device is also activated to detect obstacles in a predetermined pivot range of the door leaf. When an obstacle is detected in the pivot range, an object classification algorithm is performed using the obstacle detection device to identify the object class of the detected obstacle. Depending on the identified object class, a collision avoidance measure is initiated by the obstacle detection device to limit an unwanted collision with the detected obstacle when pivoting the door leaf.

### FIELD

The invention relates to a method for pivoting of a movable door leaf of a vehicle door using an electric drive device. Furthermore, the invention relates to a vehicle door system with an electric drive device for pivoting of a movable door leaf of a vehicle door. Furthermore, the invention relates to a motor vehicle with at least one vehicle door and with a corresponding vehicle door system.

### BACKGROUND

There is a trend towards equipping modern vehicles with electric door drives for moving a vehicle door. The electric door drive is implemented, for example, by an electric drive device, such as an electric motor, which can move the door between an open position and a closed position. There are various further development stages available for such a door drive.

For example, the door drive can be fully automated. Here, the movement of the door is automatically started and stopped in response to a single user action (e.g., briefly tapping a switch). To prevent collisions with obstacles in the vicinity of the door, the fully automatic door drive is usually coupled with an obstacle detection system that can, for example, slow down the door movement.

For example, DE 10 2015 119 505 A1 discloses a door component with a controllable damping device for controllable damping of a pivoting movement of a vehicle door. The damping device can be used indirectly for obstacle detection, for example by setting a greater damping level when the door suddenly experiences a strong deceleration. This can happen, for example, when a gust of wind moves the door in the closing direction and a leg, hand, or other object is in the way.

Another further development stage is the semi-automatic door drive. The operation is carried out by the user continuously operating an operating point (e.g., holding the switch). The door then moves automatically. Obstacle detection is generally not necessary here, as it is assumed that the operator has an eye on the surroundings. The responsibility for collision avoidance is therefore transferred to the operator.

A further development stage is the servo-assisted door drive. The operating action then involves the user grasping or holding the door at a specific operating point, such as the handle or another location, and performing the movement to open or close it. In this case, the drive device supports the movement wanted by the operator, thus reducing the effort required by the user. This makes the door feel feather-light to the user.

The servo-assisted operation of a vehicle door is known, for example, from DE 10 2019 121 640 A1. In the process, a target voltage is adjusted as a function of a target current for an electric drive motor used to pivot a door leaf, depending on the angular velocity of the door leaf. This allows the user to maintain control over the door at all times while guiding its movement, yet the door feels feather-light. Sensors can also be provided for the door to detect whether there are any obstacles in front of it. The door can be braked to prevent damage to the vehicle.

When using obstacle detection with a servo-assisted door drive, it can happen that the operator is detected as an obstacle. The door is then unintentionally slowed down, even though the operator actually wants to move the door further. Therefore, servo assistance is usually implemented without obstacle detection.

However, in particular, a servo-assisted door drive cannot distinguish between intentional user actuation and, for example, a gust of wind, so the servo drive may start moving unintentionally. A gust of wind would therefore activate the servo-assisted mode. In extreme cases, the door will collide with an obstacle because no obstacle detection is implemented.

### SUMMARY

The object of the present invention is to implement a servo-assisted door drive that reliably responds to an operating action and avoids damage caused by collisions with obstacles when the vehicle door is pivoted.

Advantageous embodiments of the invention are disclosed by the claims, the description, and the figures.

According to one aspect, the invention relates to a method for pivoting of a movable door leaf of a vehicle door. An electric drive device is activated to influence the pivoting of the door leaf, at least partially, between an open position and a closed position, depending on an actuating force exerted on the door leaf. When the drive device is activated, an obstacle detection device is simultaneously activated to detect obstacles within a predetermined pivot range of the door leaf. By means of the obstacle detection device, an object classification algorithm is performed on the detected obstacle when an obstacle is detected in the pivot range, in order to identify an object class of the detected obstacle. Depending on the identified object class, a collision avoidance measure is initiated by means of the obstacle detection device in order to limit or avoid an unwanted collision with the detected obstacle when the door leaf pivots.

In other words, obstacle detection is also performed every time the servo assistance is started. The obstacle detection returns the object class of the detected obstacle as a result. The object class can be used to deduce the cause of the actuation force. If, for example, a person is detected as the object class, it can be assumed that the person is an operator who is actuating or wants to actuate the vehicle door. If, on the other hand, for example, another obstacle, such as an object or thing, is detected, it can be assumed that a disturbance event, such as a gust of wind, exerted the actuating force. In this case, the servo assistance was therefore triggered unintentionally, especially outside of a user request. Then it makes sense to initiate a collision avoidance measure, since the operator should not be responsible for monitoring the surroundings in this case.

This offers the advantage that the collision avoidance measure can be specifically activated when a corresponding disturbance event occurs. This effectively prevents damage to the vehicle or the obstacle. At the same time, the obstacle detection is prevented from classifying the operator as an obstacle. This prevents unwanted braking maneuvers or similar collision avoidance measures. The power steering is particularly reliable.

The vehicle door could be, for example, a side door, a trunk lid and/or a frunk lid or another type of vehicle door. The vehicle door or door leaf is designed as a hinged door. This means it is a door whose door leaf is hinged or attached to an edge by means of door hinges or door pivots. This type of door pivots outwards around the door hinges. The door therefore moves around a pivot axis that runs along the edge where the door is attached to the vehicle body, for example, by the door hinges. In particular, there is no shifting, as is the case, for example, with a sliding door, which is usually guided or moved along two edges.

The pivot range refers in particular to a range in which the door leaf is moved when pivoting between the open position and the closed position. The pivot range is preferably determined by the dimensions of the door leaf depending on the stop point on the body. The pivot range can, for example, be a radius around the stop edge, predetermined by the length of the door leaf.

The open position refers to the position of the door leaf in which the door leaf is fully open. The closed position refers to the position of the door leaf in which the door leaf is fully closed. The assisted pivoting can occur partially or completely between these two positions. This means that when pivoting, there are positions that lie between the open position and the closed position.

The actuating force can be exerted by an operator, a disturbance event, or a disturbance variable. The disturbance event could be, for example, wind, especially a gust of wind, or be caused by gravity, for example when parking on an inclined plane. To activate the drive device, a predetermined actuation impulse or force application is necessary. This means that a minimum force is specified to trigger the servo assistance.

To exert the actuating force, the operator can touch or hold the door leaf at any point or position, also known as the operating point, and then guide it in the wanted direction of movement. The operating point can be, for example, a door handle, but also any other position on the door leaf.

The drive device is used for servo assistance. This reduces the force (minimum force) required to pivot the door. The drive device preferably comprises an electric motor or drive motor. This motor is used for servo assistance, for example during servo operation, and can therefore influence, i.e., support, the pivoting. However, the force generated by the drive motor is not sufficient to open the door leaf on its own. This means that an additional actuating force from the outside is always necessary, for example from the operator or the disturbance event.

The use or implementation of a drive device for servo-assisted pivoting of a door leaf is known per se and is described, for example, in DE 10 2019 121 640 A1. Here, the electrical input voltage of the drive motor is adjusted by the motor depending on the current detected.

Object classification is carried out using known methods. Object classification is performed using the object classification algorithm, which can also be designed as an object detection algorithm. The aim is to process an input image or environment image, which can be captured by means of the obstacle detection device and may contain the pivot range, in a manner known per se. The processing results in the identification of objects in the image. For this purpose, the image is divided, for example, into regions or sections, which are then examined for specific features in order to assign the image regions to a class of objects. Object classification is preferably carried out using computer-implemented methods. For this purpose, a machine learning model can be used, for example. The machine learning model could, for example, be an artificial neural network. In order to perform the classification, the machine learning model can, for example, be trained with appropriate training data.

The invention also includes embodiments which result in additional advantages.

In one embodiment, the collision avoidance measure is only initiated if the obstacle is recognized as a thing according to the identified object class. In this context, “thing” refers in particular to a physical thing in the legal sense, i.e., an object. Otherwise, i.e., only if the identified object class is detected as a person, for example, the collision avoidance measure remains deactivated. The aim here is to exclude the detected object as the user or operator in order to be able to draw conclusions about the cause of the operating force, as described above.

In one embodiment, if the obstacle is detected as a person according to the identified object class, an anatomical operating range of the detected person for operating the door leaf is determined. The collision avoidance measure is only initiated if the door leaf is outside the operating range.

A check is thus performed to determine whether it is anatomically possible at all for the operator to trigger the mechanism for pivoting the door leaf by applying the actuation force. However, if it can be ruled out based on human anatomy that the wish to activate originated from a person, it can be assumed that the actuation was not wanted and occurred, i.e., for example, due to a disturbance event. Then the responsibility for surroundings monitoring for obstacle detection should be transferred to the “vehicle” system, and obstacle detection with activated collision avoidance should remain switched off.

The operating range can be determined, for example, based on the person's body measurements. For example, body measurements can correspond to the length of the person's arms. In addition to object classification, for example, the obstacle detection device can in this case also determine the length of the arms and the distance of the operator relative to the door leaf using image processing. If the body dimensions, i.e., for example the length of the arms, are too short to move the door leaf at a relative distance between the person and the vehicle door, it can be assumed that the person did not apply the operating force.

In one embodiment, the collision avoidance measure remains prevented only if the door leaf is located within the operating range. This means that if, for example, the person's body dimensions and, in particular, their relative distance to the vehicle door indicate that the operator could potentially open the door, the responsibility for monitoring the surroundings to avoid collisions remains with the operator. It is in fact assumed that the operator exerts the operating force and thus guides the door leaf during the pivoting.

In one embodiment, the collision avoidance measure comprises stopping the pivoting of the door leaf by means of a brake device and/or slowing down or damping the pivoting speed of the door leaf and positioning the door leaf against the obstacle and/or moving the door leaf, depending on the position of the detected obstacle relative to the door leaf, either into the open position or the closed position, preferably by changing the direction of the pivoting movement.

To initiate or trigger the collision avoidance measure, the obstacle detection device, in particular a control device of the obstacle detection device, can, for example, actuate the brake device and/or the drive device. When actuated with a corresponding control signal, the brake device or the drive device performs the corresponding action to avoid or limit the collision with the obstacle.

This means that the vehicle door can be coupled with a brake device to dampen, brake or block the door leaf during the pivoting movement. The brake device could, for example, comprise a rotary brake or a rotary damper. Additionally or alternatively, the pivoting movement can be redirected by means of the brake device and the drive device, so that a change in the direction of the pivoting movement occurs.

In one embodiment, the seat occupancy status of a vehicle seat assigned to the vehicle door is determined. The collision avoidance measure is additionally initiated by means of the obstacle detection device only if the vehicle seat is unoccupied according to the determined seat occupancy status.

This means that seat occupancy can also be queried additionally. Depending on whether the seat detection is active or inactive at the corresponding position in the vehicle where the vehicle door is to be moved, the decision to limit the collision can be influenced. This makes it possible, in particular, to rule out, for example, that the servo assistance was requested by an operator sitting in the vehicle whom the obstacle detection device could not detect as an obstacle in the pivot range.

To detect the seat occupancy status, the vehicle seat can, for example, be equipped with a seat occupancy sensor. The sensor system can comprise one or more sensors, which are located, for example, in a seat surface of the vehicle seat. The respective sensor can be designed, for example, as a pressure sensor or force sensor. Of course, other types of seat occupancy sensors are also conceivable.

In one embodiment, a sensor unit with at least one radar sensor and/or at least one lidar sensor and/or at least one camera and/or at least one ultrasonic sensor and/or at least one closing force sensor is used in the pivot range for obstacle detection by means of the obstacle detection device.

This means that the sensor unit can have one or more corresponding sensors for monitoring the pivot range. The pivot range can therefore lie within the detection range of the respective sensor.

If the sensor unit comprises a so-called closing force sensor, it can be used to measure external forces. This is particularly helpful if, for example, the door leaf is moving in the closing direction and the operator is located between the door leaf and the vehicle because the operator is about to get out or unload something. In this case, the closing force sensor can detect when the door leaf touches the operator as obstacle.

For applications or usage situations that can arise in the method and which are not explicitly described here, it can be provided according to the method that a fault message and/or a request for input of user feedback is output and/or a standard setting and/or a predetermined initial status are set.

According to another aspect, the invention relates to a vehicle door system for pivoting of a movable door leaf of a vehicle door. The door system comprises an electric drive device which is designed to influence the pivoting of the door leaf, at least partially, between an open position and a closed position, depending on an actuating force exerted on the door leaf. Furthermore, a control device is provided which is designed to activate the electric drive device depending on the actuating force. The control device is designed to activate an obstacle detection device when the drive device is activated. The obstacle detection device is designed to detect obstacles in a predetermined area of the door leaf. Furthermore, the obstacle detection device is designed to perform an object classification algorithm when an obstacle is detected in the pivot range in order to identify an object class of the detected obstacle. In addition, depending on the identified object class, the obstacle detection device is designed to initiate a collision avoidance measure in order to limit or avoid an unwanted collision with the detected obstacle when the door leaf pivots.

This means that the vehicle door system according to the invention can carry out or perform the method according to the invention. In particular, the vehicle door system according to the invention carries out the method according to the invention.

In this application, the terms “control device” or “control apparatus” or “control unit” are used synonymously. The control device can have a data processing unit or a processor device (processor circuit) which is configured to implement an embodiment of the method according to the invention. For this purpose, the processor device can have at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as a microprocessor in each case. Furthermore, the processor device can have a program code which is configured to implement the embodiment of the method according to the invention when it is carried out by the processor device. The program code can be stored in a data memory of the processor device. The processor device can be based, for example, on at least one circuit board and/or at least one SoC (System on Chip).

The program code is stored, for example, on a computer-readable storage medium. When the program code is executed by a computer or a computer network, it is caused to carry out an embodiment of the method according to the invention. The storage medium can be provided, for example, at least partially as a non-volatile data memory (e.g., as a flash memory and/or as an SSD -Solid State Drive) and/or at least partially as a volatile data memory (e.g., as a RAM-Random Access Memory). The storage medium can be arranged in the computer or computer network. However, the storage medium can also be operated, for example, as a so-called app store server and/or cloud server on the Internet. A processor circuit with, for example, at least one microprocessor can be provided by the computer or computer network. The program code can be provided as binary code and/or as assembler code and/or as source code of a programming language (e.g., C) and/or as a program script (e.g., Python). The computer-readable storage medium can alternatively be implemented by a signal containing computer-readable data, e.g., a time-varying voltage signal and/or a radio signal.

According to another aspect, the invention relates to a motor vehicle with at least one vehicle door and with a vehicle door system for the vehicle door. This means that the motor vehicle can have one or more vehicle doors with a respective vehicle door system by means of which the method according to the invention can be carried out or performed.

The motor vehicle according to the invention is preferably designed as an automobile, in particular as a passenger car or truck, or as a passenger bus or motorcycle.

The invention also includes further developments of the motor vehicle according to the invention and of the vehicle door system according to the invention, which have features as already described in the context of the further developments of the method according to the invention. For this reason, the corresponding further developments of the motor vehicle according to the invention and of the vehicle door system according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. For this purpose:

FIG. 1 shows a schematic representation of a motor vehicle with a vehicle door system for servo-assisted pivoting of a movable door leaf of a vehicle door; and

FIG. 2 shows a schematic representation of the motor vehicle, according to FIG. 1 with an operator in the pivot range of the door leaf; and

FIG. 3 shows a schematic process flow diagram for a method for pivoting the movable door leaf of the vehicle door.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

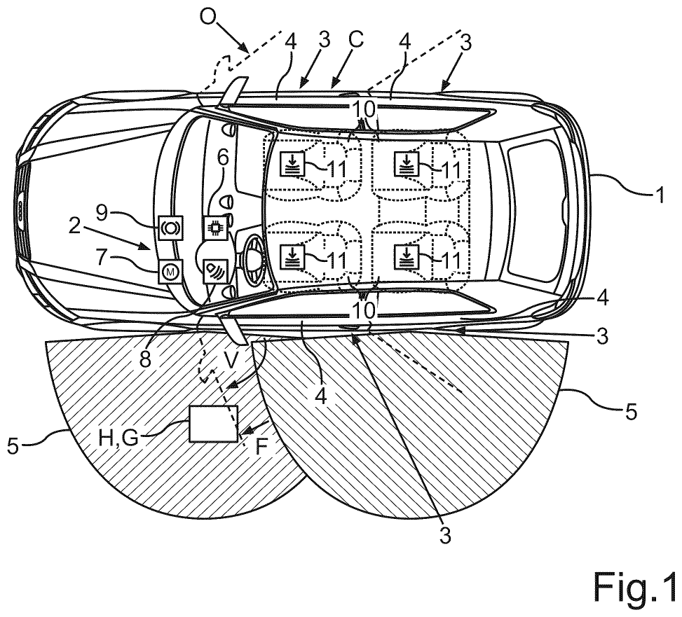

FIG. 1 shows a schematic top view of a motor vehicle 1. The motor vehicle 1 is shown, for example, as a passenger car. The motor vehicle 1 comprises several vehicle doors 3, which are shown here, for example, as side doors or passenger doors. Of course, another type of vehicle door, such as a trunk lid or frunk lid, can also be provided. In this case, the respective vehicle door 3 is designed as a hinged door or a pivot door. Its door leaf 4 is therefore only attached to the body at one edge by means of door hinges, so that when the vehicle door is moved, the door leaf 4 pivots out in a pivoting movement V around the door hinges.

The motor vehicle 1 also comprises a vehicle door system 2 for servo-assisted pivoting or moving of the respective door leaf 4. In the present embodiment, for the sake of clarity, only one vehicle door system for one of the vehicle doors 3 is shown. The motor vehicle 1 can of course comprise several such vehicle door systems 2, for example one for each vehicle door 3. Alternatively, it is conceivable, for example, that several vehicle doors 3 share one or more components of a vehicle door system 2. The vehicle door system 2 here comprises, by way of example, a control device 6, an electric drive device 7, an obstacle detection device 8, and a brake device or damping device 9.

The drive device 7 provides servo assistance when pivoting the door leaf 4. For this purpose, the drive device 7 comprises, for example, a drive motor or an electric motor. In this case, the servo assistance works as follows: If an actuating force F, i.e., a predetermined actuating impulse is exerted with a certain force on the door leaf 4, the drive device 7, in particular the electric motor, is activated and, in the process, influences the pivoting of the door leaf 4. In the process, the door leaf 4 is moved at least partially between an open position O and a closed position C. The drive device 7 therefore supports the pivoting, so that the force required for the actuating force F to open or close the vehicle door 3 is reduced.

The actuating force F can, for example, be exerted by an operator not shown. For this purpose, the operator can grasp the door leaf 4, for example at any operating point, such as a door handle, and move it in the wanted direction to pivot. The operator therefore performs the pivoting movement V.

Alternatively, the actuating force F may be applied by a disturbance event. The disturbance event could be, for example, a gust of wind. Another type of disturbance event is caused, for example, by gravity, if the motor vehicle 1 is parked on a slope.

The control device 6 is provided to activate the drive device 7 depending on the actuating force F. The control device 6 can therefore detect the actuating force F and then switch on the servo assistance. The detection of the actuating force F can be determined, for example, based on a measured quantity of the drive device 7. The measured quantity is established when the door leaf 4 is subjected to the actuating force F in the electric motor. The measured quantity is, for example, a rotational speed, or a current, or a voltage of the electric motor. Alternatively, it is conceivable, for example, to use a position sensor to record a characteristic value for a speed of the door leaf 4, i.e., for example an angular velocity, as a measured quantity M.

The control device 6 can, for example, be implemented as a data processing device or computing unit. It can comprise one or more microcontrollers or microprocessors, for example.

The obstacle detection device 8 comprises a sensor unit with at least one sensor. In the present embodiment, the sensor is designed, for example, as a radar sensor. Alternatively, for example a lidar sensor, a camera, an ultrasonic sensor and/or a closing force sensor can be provided. The obstacle detection device 8 is intended to monitor a pivot range 5 of the door leaf 4. The aim is to detect and, if necessary, classify obstacles within the pivot range 5. This should at least limit or even prevent a collision with a corresponding obstacle H if necessary.

In this context, the pivot range 5 refers to the range in which the door leaf 4 is moved when pivoting between the closed position C and the open position O. In order to monitor the pivot range 5, the respective sensor is attached in this case to the motor vehicle 1 in such a way that the pivot range 5 lies within the detection range of the respective sensor unit.

For obstacle detection and/or classification, the obstacle detection device 8 can, for example, execute or perform an object detection algorithm and/or an object classification algorithm. For this purpose, the obstacle detection device 8 can, for example, process a surroundings image that depicts at least the pivot range 5 in a known manner in order to identify individual objects in the image. For this purpose, the image is divided, for example, into regions, which are then examined for features in order to assign the image section or image region to a class of objects. In this case, one object class could be the class “obstacle.” Here, any object that causes damage or harm upon collision with the door leaf can be considered an obstacle H. In the embodiment shown in FIG. 1, the obstacle H is, for example, an object or a thing. For example, a boundary pillar is shown here. Of course, other types of objects can also be included as obstacle H, such as a bush, another vehicle, and so on.

The brake device 9 is designed to dampen, brake or block the pivoting movement of the door leaf 4. For this purpose, the brake device 9 can comprise, for example, a rotary brake or a damping device. The brake device 9 can thus be used to carry out a collision avoidance measure if, for example, the obstacle detection device 8 detects an obstacle H in the pivot range 5. This prevents an unwanted collision of the door leaf 4 with the obstacle H, or allows it to be carried out in a controlled manner, for example. This will prevent damage to the vehicle 1 or the obstacle H.

For each vehicle door 3, the motor vehicle 1 according to the exemplary embodiment in FIG. 1 also comprises a vehicle seat 10. In this case, the respective vehicle seat 10 is equipped with a seat sensor system 11. The seat sensor system 11 comprises at least one seat sensor to detect the seat occupancy status of the vehicle seat 10. Here, the seat occupancy sensor can, for example, be designed as a pressure sensor. Of course, any other type of seat sensor can be used. The seat occupancy status indicates whether a person is in vehicle seat 10 or not (vehicle seat occupied or unoccupied). The determination of the seat occupancy status using appropriate seat sensors 11 is carried out according to known methods.

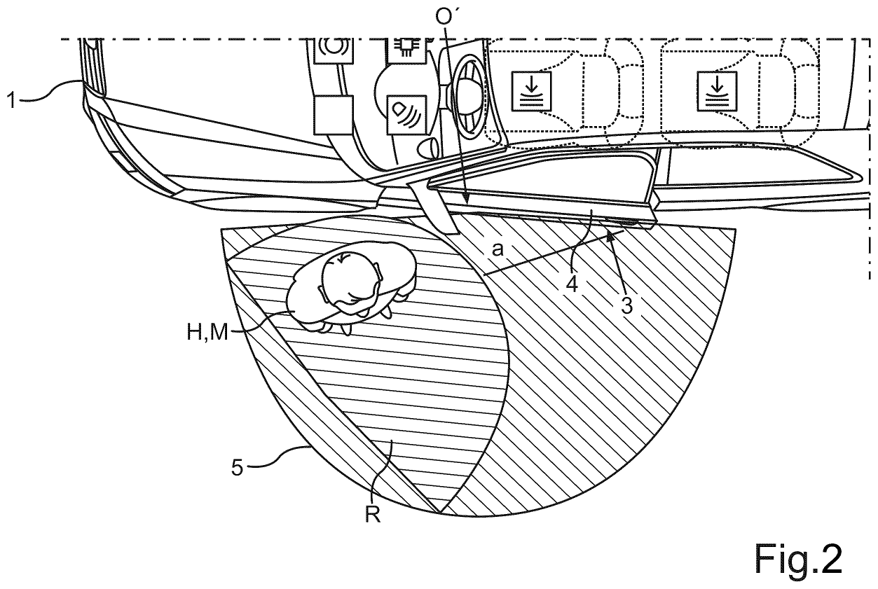

FIG. 2 shows a schematic representation of a section of the vehicle 1, according to FIG. 1. FIG. 2 shows the vehicle door in a partially open opening status O'. In this embodiment, the obstacle H is not an object, but a person M, i.e., a human being. FIG. 2 shows that the person M is located within the pivot range 5 and could therefore be detected as an obstacle H by the obstacle detection device 8. However, the object classification would then reveal that the obstacle H is a person, and it could therefore be assumed in principle that the actuating force and thus the operating request of the door leaf 4 was exerted by the person M as the operator.

However, as can be seen in FIG. 2, the person M is at such a large distance a from the vehicle door 3, in particular from the door handle, that the person M could not have performed the operation. The operating range R, which is determined, for example, by the length of the person M's arms, is anatomically insufficient for the person M to reach, for example, the door handle to open vehicle door 3.

It can therefore be anatomically ruled out that the person M is responsible for the action. The actuating force F can therefore only have been exerted by a disturbance event, in this case, for example a gust of wind. Then it makes sense to use the collision avoidance measure to avoid a collision with the obstacle H, in this case, for example, the person M.

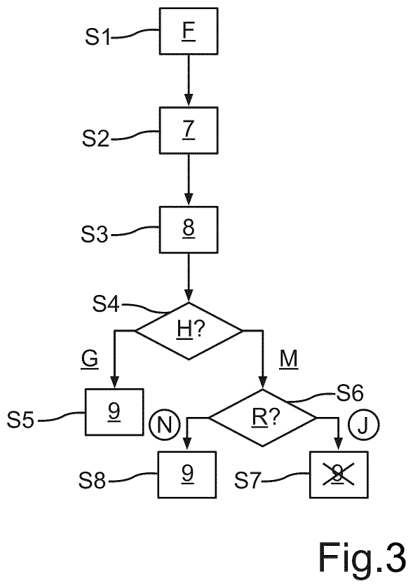

The described vehicle door system 2 should now make it possible to distinguish between an intentional actuation of the vehicle door 3 by an operator and an unintentional actuation due to a disturbance event, such as a gust of wind or due to gravity. Depending on this, the collision avoidance measure should then be performed. In this context, FIG. 3 shows a schematic process flow diagram for a method for operating a corresponding vehicle door system 2 for pivoting the movable door leaf 4 of the vehicle door 3.

In step S1, for example, the actuating force F is first recorded by means of the control device 6, as described. Regardless of whether the actuating force F is initially exerted by an operator or by a disturbance event, the electric drive device 7 is activated in step S2. When activated, the drive device 7 influences the pivoting of the door leaf 4 between the open position O and the closed position C. In this case, the drive device 7 supports the pivoting, in particular, as long as the actuating force F is exerted on the door leaf 4.

In step S3, for example, the control device 6 also activates the obstacle detection device 8 together with the drive device 7. The obstacle detection device 8 then performs the obstacle detection with the object classification described above. As a classification result, the obstacle H can be assigned either to the object class “object G” or to the object class “person M.” The obstacle detection device 8 checks the assignment to the respective object class in step S4 of the procedure.

If it turns out that the obstacle H is assigned to the object class object G, the procedure continues in step S5. In step S5, the collision avoidance measure is initiated. For this purpose, for example, the obstacle detection device 8 controls the brake device 9. The brake device 9 then performs the collision avoidance measure. The collision avoidance measure can, for example, comprise damping or slowing down the pivoting movement of the door leaf 4. Additionally or alternatively, for example, after braking, a change in the direction of the pivoting movement can be carried out, so that the door leaf 4 is moved, for example, from the opening position O to the closing position C or vice versa.

However, if it turns out in step S4 that the obstacle is assigned to the object class person M, the method is continued in step S6. In step S6, the obstacle detection device 8 detects or determines the anatomical operating range R of the person M. Based on the operating range R and preferably the distance a to the door leaf 4, in particular its operating point, the obstacle detection device 8 checks whether the operating range R is sufficient for the person M to have been able to perform the operation. For this purpose, the obstacle detection device 8 checks whether the door leaf 4 is located outside or inside the operating range R.

If it turns out that the door leaf 4 is within the operating range (J), the procedure continues in step S7. In step S7, the collision avoidance measure remains prevented or deactivated. In this case, it can in fact be assumed that the person M, as the operator, initiated the operation of vehicle door 3 and that it was therefore a deliberate actuation. Using the collision avoidance measure in this case would then result in the damping or braking of the door being carried out undesirably. This can lead to a poor user experience for the operator.

However, if it turns out in step S6 that the door leaf 4 is located outside of the operating range R (N), the method is continued in step S8. In step S8, the collision avoidance measure is initiated. In this case, it can be assumed that the person M is not an operator, since this is anatomically impossible. The operation must therefore have been initiated by a disturbance event, making collision avoidance necessary here. This is intended, for example, to prevent the person M, as an obstacle H, from being hit by the door leaf 4 during the pivoting process.

To initiate the collision avoidance measure, the brake device 9 is actuated by means of the obstacle detection device 8. The brake device 9 carries out the corresponding collision avoidance measure.

It may happen that the actuating force F is exerted by an operator who is located inside the vehicle, for example on one of the vehicle seats 10. In the process, the operator cannot be detected by the obstacle detection device 8, whose detection range lies in particular in the surroundings, i.e., in the exterior area of the motor vehicle 1. Therefore, it is preferably provided that the vehicle seat 10 assigned to the respective vehicle door 3 is checked for its occupancy status. The seat occupancy status is detected, for example, by means of the seat occupancy sensor 11 in a known manner. The collision avoidance measure is additionally initiated in step S5 or step S8 only if the vehicle seat 10 is unoccupied according to the determined seat occupation status. Unoccupied means that there is no person M in vehicle seat 10. This eliminates therefore the possibility that the power steering assistance was requested, for example, by a user sitting in the vehicle whom the radar sensor cannot detect.

Overall, the exemplary embodiments show the opening of an electrically driven vehicle door 4 by a disturbance event, such as wind.

1. A method for pivoting of a movable door leaf of a vehicle door, wherein an electric drive device is activated to influence the pivoting of the door leaf, at least partially, between an open position and a closed position, depending on an actuating force exerted on the door leaf, the method comprising:
when the drive device is activated, an obstacle detection device is activated to detect obstacles in a predetermined pivot range of the door leaf, wherein, when an obstacle is detected in the pivot range, an object classification algorithm is performed by the obstacle detection device to identify an object class of the detected obstacle and, depending on the identified object class, a collision avoidance measure is initiated by the obstacle detection device to limit an unwanted collision with the detected obstacle when pivoting the door leaf.

2. The method according to claim 1, wherein the collision avoidance measure is initiated only if the obstacle is detected as a thing according to the identified object class.

3. The method according to claim 1, wherein, in the event that the obstacle is detected as a person according to the identified object class, an anatomical operating range of the detected person for operating the door leaf is determined, and the collision avoidance measure is initiated only if the door leaf is located outside the operating range.

4. The method according to claim 3, wherein the collision avoidance measure remains prevented only if the door leaf is located within the operating range.

5. The method according to claim 1, wherein the collision avoidance measure comprises stopping the pivoting of the door leaf by the drive device and/or slowing down or damping a pivoting speed of the door leaf and positioning the door leaf against the obstacle and/or moving the door leaf, depending on the position of the detected obstacle relative to the door leaf, either into the open position or the closed position.

6. The method according to claim 1, wherein a seat occupancy status of a vehicle seat assigned to the vehicle door is determined, and the collision avoidance measure is additionally initiated by the obstacle detection device only if the vehicle seat is unoccupied according to the determined seat occupancy status.

7. The method according to claim 1, wherein a sensor unit with at least one radar sensor and/or at least one lidar sensor and/or at least one camera and/or at least one ultrasonic sensor and/or at least one closing force sensor is used in the pivot range for obstacle detection by the obstacle detection device.

8. A vehicle door system for pivoting a movable door leaf of a vehicle door, including
an electric drive device which is designed to influence the pivoting of the door leaf, at least partially, between an open position and a closed position, depending on an actuating force exerted on the door leaf, and
a control device which is designed to activate the electric drive device depending on the actuating force,
wherein the control device is configured to activate an obstacle detection device when the drive device is activated, wherein the obstacle detection device is configured to detect obstacles in a predetermined pivot range of the door leaf,
wherein the obstacle detection device is designed to perform an object classification algorithm, when an obstacle is detected in the pivot range, to identify an object class of the detected obstacle and to initiate a collision avoidance measure depending on the identified object class to limit an unwanted collision with the detected obstacle when pivoting the door leaf.

9. A motor vehicle with at least one vehicle door and with a vehicle door system according to claim 8.

10. The method according to claim 2, wherein, in the event that the obstacle is detected as a person according to the identified object class, an anatomical operating range of the detected person for operating the door leaf is determined, and the collision avoidance measure is initiated only if the door leaf is located outside the operating range.

11. The method according to claim 2, wherein the collision avoidance measure comprises stopping the pivoting of the door leaf by the drive device and/or slowing down or damping a pivoting speed of the door leaf and positioning the door leaf against the obstacle and/or moving the door leaf, depending on the position of the detected obstacle relative to the door leaf, either into the open position or the closed position.

12. The method according to claim 3, wherein the collision avoidance measure comprises stopping the pivoting of the door leaf by the drive device and/or slowing down or damping a pivoting speed of the door leaf and positioning the door leaf against the obstacle and/or moving the door leaf, depending on the position of the detected obstacle relative to the door leaf, either into the open position or the closed position.

13. The method according to claim 4, wherein the collision avoidance measure comprises stopping the pivoting of the door leaf by the drive device and/or slowing down or damping a pivoting speed of the door leaf and positioning the door leaf against the obstacle and/or moving the door leaf, depending on the position of the detected obstacle relative to the door leaf, either into the open position or the closed position.

14. The method according to claim 2, wherein a seat occupancy status of a vehicle seat assigned to the vehicle door is determined, and the collision avoidance measure is additionally initiated by the obstacle detection device only if the vehicle seat is unoccupied according to the determined seat occupancy status.

15. The method according to claim 3, wherein a seat occupancy status of a vehicle seat assigned to the vehicle door is determined, and the collision avoidance measure is additionally initiated by the obstacle detection device only if the vehicle seat is unoccupied according to the determined seat occupancy status.

16. The method according to claim 4, wherein a seat occupancy status of a vehicle seat assigned to the vehicle door is determined, and the collision avoidance measure is additionally initiated by the obstacle detection device only if the vehicle seat is unoccupied according to the determined seat occupancy status.

17. The method according to claim 5, wherein a seat occupancy status of a vehicle seat assigned to the vehicle door is determined, and the collision avoidance measure is additionally initiated by the obstacle detection device only if the vehicle seat is unoccupied according to the determined seat occupancy status.

18. The method according to claim 2, wherein a sensor unit with at least one radar sensor and/or at least one lidar sensor and/or at least one camera and/or at least one ultrasonic sensor and/or at least one closing force sensor is used in the pivot range for obstacle detection by the obstacle detection device.

19. The method according to claim 3, wherein a sensor unit with at least one radar sensor and/or at least one lidar sensor and/or at least one camera and/or at least one ultrasonic sensor and/or at least one closing force sensor is used in the pivot range for obstacle detection by the obstacle detection device.

20. The method according to claim 4, wherein a sensor unit with at least one radar sensor and/or at least one lidar sensor and/or at least one camera and/or at least one ultrasonic sensor and/or at least one closing force sensor is used in the pivot range for obstacle detection by the obstacle detection device.
